(19) United States
(12) Patent Application Publication
(10) Pub. No.: US 2026/0171529 A1
(43) Pub. Date: Jun. 18, 2026

(54) XGBoost-Based Error Compensation Method for Acoustic Source Localization of Lithium-Ion Battery Thermal Runaway

(71) Applicant: Nanjing Tech University, Nanjing City (CN)

(72) Inventors: Yangyan Zheng, Nanjing City (CN); Rongrong Ji, Nanjing City (CN); Tao Zhao, Nanjing City (CN); Zhirong Wang, Nanjing City (CN); Zhenqi Lu, Nanjing City (CN); Qi Zhang, China (CN)

(21) Appl. No.: 19/419,080

(22) Filed: Dec. 14, 2025

(30) Foreign Application Priority Data
Dec. 15, 2024 (CN) 202411844059.9

(51) Int. Cl. H01M 10/48; G01K 11/24; H01M 50/251; H01M 50/375; H04R 1/40; H04R 3/00

(52) U.S. Cl. CPC H01M 10/486; G01K 11/24; H01M 50/251; H01M 50/375; H04R 1/406; H04R 3/005; G01K 2213/00; H01M 2200/10; H04R 2201/405

(57) ABSTRACT

The present invention discloses an XGBoost-based lithium-ion battery thermal runaway acoustic source localization error compensation method. Acoustic signals in an energy storage cabin are collected using a fixed microphone array, including time delay data, cross power spectrum data, and acoustic source localization coordinates calculated by a conventional geometric method. The localization error is calculated by comparing the geometric localization coordinates with actual acoustic source position coordinates, and a feature vector is constructed based on the extracted acoustic features. These feature vectors are used to train an XGBoost model. In practical applications, real-time time delay data, cross power spectrum data, and geometric localization coordinates are input into the trained model, and the predicted error value is used to correct the geometric acoustic source localization results, thereby obtaining a more accurate acoustic source position for a thermal runaway lithium-ion battery.

### TECHNICAL FIELD

The present invention belongs to the technical field of lithium-ion battery safety, and particularly relates to an XGBoost-based lithium-ion battery thermal runaway acoustic source localization error compensation method.

### BACKGROUND ART

Lithium-ion batteries have the characteristics of long discharge duration, fast response speed, high conversion efficiency, independence from natural conditions, and convenience for large-scale application, making them the main development direction for electrochemical energy storage power stations. However, lithium-ion batteries use an organic electrolyte with a low boiling point and high flammability, and their material system has a high calorific value. Moreover, no effective fault early warning method is currently available. Once a fault occurs in the battery cell or electrical equipment, exothermic side reactions of the battery materials are easily triggered, leading to battery thermal runaway, which may further escalate into major safety accidents such as combustion and explosion of the energy storage system.

To prevent explosion of the sealed metal casing, lithium-ion batteries are equipped with a safety valve on the top. The safety valve is standard on each lithium-ion battery and serves as the most important explosion-proof barrier. When the internal pressure of the battery becomes too high, the safety valve on the top of the battery opens to release pressure and prevent an explosion. When the safety valve opens, a specific sound signal is generated, and thermal runaway is not severe. Timely and effective identification and localization of this acoustic signal enable early warning of thermal runaway, making fault handling more targeted.

The traditional lithium-ion battery thermal runaway localization method mainly relies on a spatial positioning algorithm, which acquires the acoustic source signal via a microphone array and calculates the time delay difference of the signal received by each microphone to derive the acoustic source position. Microphone arrays are typically configured in a linear or two-dimensional arrangement to ensure that acoustic source signals are captured within a certain range. The position of each microphone is known, and the accuracy of acoustic source localization is optimized by adjusting the spacing between microphones. In particular, the sound waves emitted by the acoustic source propagate at a fixed speed (approximately 343 m/s in air) to each microphone. The time difference (time delay difference) of the sound wave arriving at different microphones can be calculated by dividing the distance difference between the acoustic source and the two microphones by the speed of sound. With the known microphone positions and the time delay differences between each pair of microphones, a system of equations can be established, and the three-dimensional coordinates of the acoustic source can be derived using the geometric method. This typically involves measurements from at least three microphones to ensure the accurate position of the acoustic source. However, in practical applications, the noise environment in the battery compartment is complex and diverse, including equipment operation noise and airflow noise. These noises interfere with time delay measurement, thereby affecting localization accuracy. The accuracy of spatial locating methods generally depends on the geometry of the microphone array and on ideal assumptions about the speed of sound. Any irregular microphone arrangement, change in speed of sound, or failure of the microphones in the array can result in significant errors in localization. In addition, in complex scenes, the acoustic source propagation path may be affected by reflection, diffraction, and other nonlinear factors, further reducing localization accuracy.

### SUMMARY OF THE INVENTION

It is an object of the present invention to provide an XGBoost-based lithium-ion battery thermal runaway acoustic source localization error compensation method, which solves the technical problem of low localization accuracy of lithium-ion battery thermal runaway in the prior art—where spatial positioning algorithms are employed—caused by irregular microphone arrangements, variations in the speed of sound, microphone failures in the array, and nonlinear factors such as reflection and diffraction affecting the acoustic source propagation path.

To solve the above technical problem, the present invention adopts the following technical solution:

A XGBoost-based lithium-ion battery thermal runaway acoustic source localization error compensation method, specifically including the following steps:
Step S1: building and training a battery thermal runaway acoustic source localization error compensation system
Step S1.1: building a lithium-ion battery thermal runaway acoustic source localization error compensation system; the system includes an energy storage cabin for placing a lithium-ion battery, an acoustic acquisition assembly installed in the energy storage cabin, and a controller provided at a remote end, wherein the controller includes an acoustic signal recognition model and an XGBoost model training module;

Step S1.2: acquiring training data: specifically including the following steps:
Step S1.2.1: pre-collecting a real lithium-ion battery safety valve opening audio and storing the audio in an audio player;
Step S1.2.2: placing the audio player in the position of the lithium-ion battery in the energy storage cabin in step S1, and playing the audio, simulating a position of the real lithium-ion battery safety valve opening acoustic source, and using an acoustic acquisition assembly to acquire the audio signal for each playback;
Step S1.2.3: performing the operations of step S1.2.2 on each position where the lithium-ion battery is placed in the energy storage cabin, and repeating the operations M times for each position; using an acoustic acquisition assembly to collect four audio signals during each playback, and sending the audio signals to a controller; denoting the four audio signals as a group;
Step S1.3: the controller processing the training data acquired in step S2 and constructing a lithium-ion battery safety valve opening acoustic signal recognition model;
Step S1.4: the XGBoost model training module using the lithium-ion battery safety valve opening acoustic signal data identified by the acoustic signal recognition model to train the XGBoost model to predict localization errors;
Step S2: the acoustic sensor acquiring acoustic information in the energy storage cabin in real time and transmitting to the controller, the controller using the trained battery thermal runaway acoustic source localization error compensation system to achieve real-time accurate localization of the lithium-ion battery thermal runaway acoustic source.

With further optimization, in step S1.1, a three-dimensional coordinate system OXYZ is established in the energy storage cabin, and the true coordinates of each battery's safety valve are pre-measured;
the acoustic acquisition module includes four acoustic sensors, respectively denoted as a first acoustic sensor, a second acoustic sensor, a third acoustic sensor, and a fourth acoustic sensor; wherein the first acoustic sensor is provided at an origin of the three-dimensional coordinate system, the second acoustic sensor is provided on an X-axis of the three-dimensional coordinate system at a distance L1 from the origin; the third acoustic sensor is provided on a Y-axis of the three-dimensional coordinate system at a distance L2 from the origin; the fourth acoustic sensor is provided on a Z-axis of the three-dimensional coordinate system at a distance L3 from the origin.

With further optimization, the acoustic sensor is a microphone.

With further optimization, in step S1.2.3, the audio player is placed at a safety valve position to play audio; the audio is played 100 times at each battery safety valve position, with an audio duration of 3 seconds.

With further optimization, in step S1.3, the controller processes the training data acquired in step S2 and constructs a lithium-ion battery safety valve opening acoustic signal recognition model, specifically including the following steps:
Step S1.3.1: performing wavelet denoising on the data acquired by each acoustic sensor to remove background noise;
Step S1.3.2: processing an original audio signal by using a pre-emphasis filter to enhance the energy of high-frequency signals;
Step S1.3.3: using Mel-frequency cepstral coefficients MFCC to extract features from the read audio information, and performing normalization on the features extracted for each acoustic sensor;
Step S1.3.4: constructing a feature vector by using a preloaded SVM model, and constructing a dataset based on MFCC parameters to establish a lithium-ion battery safety valve opening acoustic signal recognition model; the lithium-ion battery safety valve opening acoustic signal data identified by the acoustic signal recognition model including the relative time delay, cross power spectrum information, the acoustic source localization coordinates calculated by the geometric method of the sound signals acquired by different sensors, and the error value between the acoustic source actual coordinates and geometric localization coordinates.

With further optimization, six time delay differences and eighteen cross power spectra corresponding to each group of audio signals, wherein the time delay differences include T₁₂, T₁₃, T₁₄, T₂₃, T₂₄, T₃₄; the real part of the cross power spectra is R₁₂, R₁₃, R₁₄, R₂₃, R₂₄, R₃₄; the imaginary part is I₁₂, I₁₃, I₁₄, I₂₃, I₂₄, I₃₄; and the magnitude is M₁₂, M₁₃, M₁₄, M₂₃, M₂₄, M₃₄; the real part, the imaginary part, the magnitude, and the error value of the time delay cross power spectra are normalized separately, and the normalizers are saved for subsequent real-time detection to normalize new data inputs for comparison.

With further optimization, the relative time delay is obtained by using the generalized cross-correlation algorithm; after windowing each group of four acquired signals, the cross power spectrum is calculated using the Fast Fourier Transform FFT, and phase normalization is applied to minimize the influence of signal strength on time delay estimation; the cross power spectrum is processed by inverse FFT to obtain the cross-correlation result, and the time delay estimation value is calculated, which provides accurate time difference data for subsequent localization;
wherein the signal is windowed to reduce spectral leakage, and the specific calculation formula is as follows:

$$w [ k ] = 0.5 ( 1 - cos ( \frac{2 π k}{K - 1} )$$

wherein w[k] is the Hanning Window function and K is the length of the signal; wherein w[k] is the Hanning Window function and K is the length of the signal; namely, the total number of signal sampling points; k represents the position index of the current window function, where k=0, 1, . . . , K−1.
windowed signal: sig˜=sig·w; refsig w_{w}=refsig·w;
w is the weight array of the window function, with a length equal to that of sig and refsig, enabling the signal edges to transition smoothly to zero and thereby reducing spectral leakage and improving the frequency-domain energy distribution.

The Fast Fourier Transform FFT calculation is performed on the sound signal:

$$SIG ( f ) = F ( {sig}_{w} ) , REFSIG ( f ) = F ( {refsig}_{w} )$$

wherein F represents the Fast Fourier Transform, and SIG(f) and REFSIG(f) are the frequency-domain representations of sig_{w} and refsig_{w}, respectively;

$$R ( f ) = SIG ( f ) \cdot REFSIG * ( f )$$

wherein REFSIG*(f) is the complex conjugate of REFSIG(f);
normalizing cross power spectrum:

$$\hat{R} ( f ) = \frac{R ( f )}{\vert R ( f ) \vert + ε}$$

wherein |R(f)| is the amplitude of the cross power spectrum, and ∈ is a constant;

$$r ( τ ) = {F}^{- 1} ( \hat{R} ( f )$$

wherein F⁻¹ represents the inverse Fourier transform and r(τ) is the cross-correlation function

$$cc = [ r ( - {τ}_{max} ) , … … , r ( - {τ}_{max} ]$$

$$τ = \frac{arg max ( \vert cc \vert ) - {τ}_{max}}{interp \cdot fs}$$

where vₘₐₓ is the maximum time delay, argmax(|cc|) is the position of the maximum cross-correlation value, interp is the interpolation factor, and fs is the sampling rate;
the real part, the imaginary part, and the magnitude of the cross-power spectrum are extracted as features:

$$Re ( R ( f ) ) = real ( R ( f ) )$$

$$Im ( R ( f ) ) = imag ( R ( f ) )$$

$$\vert ( R ( f ) \vert = \sqrt{Re {( R ( f ) )}^{2} + Im {( R ( f ) )}^{2}}$$

Wherein, R(f) is the cross power spectrum of the signal sig and the reference signal refsig, Re(R(f)) is the real part of the cross power spectrum, Im(R(f)) is the imaginary part of the cross power spectrum, and |R(f)| is the magnitude of the cross power spectrum;
with further optimization, a nonlinear equation is constructed for each acoustic sensor to represent a relationship between a distance difference from the acoustic source to the acoustic sensor and a distance difference corresponding to the time delay difference;
first, the acoustic sensor located at the coordinate origin is set as the reference acoustic sensor, and the distance R₀ from the reference acoustic sensor to the acoustic source is calculated:

$${R}_{0} = \sqrt{{x}^{2} + {y}^{2} + {z}^{2}}$$

then, the distance Rᵢ from each i^{th} acoustic sensor to the acoustic source is calculated:

$${R}_{i} = \sqrt{{( x - {x}_{i} )}^{2} + {( y - {y}_{i} )}^{2} + {( z - {z}_{i} )}^{2}}$$

then, the distance difference corresponding to the time delay difference is calculated:

$${d}_{i} = {τ}_{i} \cdot c$$

then, a nonlinear equation is constructed:

$${R}_{i} - {R}_{0} - {d}_{i} = 0$$

the nonlinear least squares method is used for optimization, the objective is to minimize the residuals of the above set of equations:

$${min}_{( x , y , z )} {\sum }_{i = 1}^{N - 1} {( \sqrt{{( x - {x}_{i} )}^{2} + {( y - {y}_{i} )}^{2} + {( z - {z}_{i} )}^{2}} - \sqrt{{x}^{2} + {y}^{2} + {z}^{2}} - {τ}_{i} \cdot c )}^{2}$$

wherein the acoustic source position coordinates are (x, y, z); (xᵢ, yᵢ, zᵢ), the position coordinate of the i^{th} acoustic sensor; τᵢ is the time delay difference of the i^{th} acoustic sensor; c is the speed of sound; R₀ the distance from the acoustic source to the reference acoustic sensor; Rᵢ is the distance from the acoustic source to the i^{th} acoustic sensor; Di is the distance difference corresponding to the time delay difference of the i^{th} acoustic sensor; N is the number of acoustic sensors; min_{(x, y, z)} is the minimized the objective function.

With further optimization, in step S1.4, acoustic source position coordinates obtained by geometric localization calculation are set as (x, y, z), and an error predicted by the XGBoost is (Δx, Δy, Δz); thus, the corrected precise acoustic source position coordinates are (x+Δx, y+Δy, z+Δz).
with further optimization, in step S2, the controller processes the received sound signal using the trained battery thermal runaway acoustic source localization error compensation system, specifically including:
step S2.1: performing normalization processing on the extracted features using the method described in step S1.3, and using a pre-trained SVM model and normalizer to predict whether the sound signal is the sound of a lithium-ion battery safety valve opening, if so, setting the lithium-ion battery as the target lithium-ion battery;
Step S2.2: acquiring acoustic signals of the target lithium-ion battery identified in the energy storage cabin in real time; calculating time delays, cross power spectrum data, and acoustic source localization coordinates calculated by a traditional geometric method; and inputting into the normalizer according to claim 6, using the pre-trained normalizer to normalize each feature data frame to ensure that different features are on the same scale; the normalized feature arrays being stacked horizontally to form a comprehensive feature matrix containing all features used for model prediction; using a loaded model to predict the combined features, and outputting an error value;
Step S2.3: using the error value predicted by the model to correct the acoustic source position coordinates output by the geometric localization method, and finally determining an accurate position of the target lithium-ion battery.

Compared with the prior art, the present invention has the following advantageous effects:

In the present invention, acoustic signals in the energy storage cabin are collected by acoustic sensors, and then the positioning error is calculated, and the feature vector is constructed by comparing the geometric localization coordinates with the actual acoustic source position coordinates. These feature vectors are used to train the XGBoost model. In practical applications, the real-time calculated time delay, cross power spectrum data, and geometric localization coordinates are input; the error value obtained from the prediction model is used to correct the traditional geometric acoustic source localization coordinates, thereby achieving real-time accurate acoustic source localization for lithium-ion battery thermal runaway. The problem of low localization accuracy of lithium-ion battery thermal runaway is solved in the prior art.

### BRIEF DESCRIPTION OF THE DRAWINGS

FIG. 1 is a schematic diagram of the battery thermal runaway acoustic source localization error compensation system according to the present invention;

FIG. 2 is a block diagram of the target lithium-ion battery localization system;

FIG. 3 is an overall diagram of the energy storage cabin constructed at a 1:1 scale;

FIG. 4 is a schematic diagram of the energy storage cabin door opening;

FIG. 5 is a schematic diagram of the microphone layout.

### DETAILED DESCRIPTION OF THE INVENTION

To make the objectives, technical solutions, and advantages of the embodiments of the present invention clearer, the technical solutions of the present invention will be described below in detail and comprehensively with reference to the accompanying drawings. Clearly, the embodiments described herein are only some embodiments of the present invention, not all embodiments. Based on the embodiments of the present invention, all other embodiments obtained by a person having ordinary skill in the art without exercising inventive effort fall within the scope of protection of the present invention.

An XGBoost-based lithium-ion battery thermal runaway acoustic source localization error compensation method, specifically including the following steps:

Step S1: building and training a battery thermal runaway acoustic source localization error compensation system, as shown in FIG. 1.

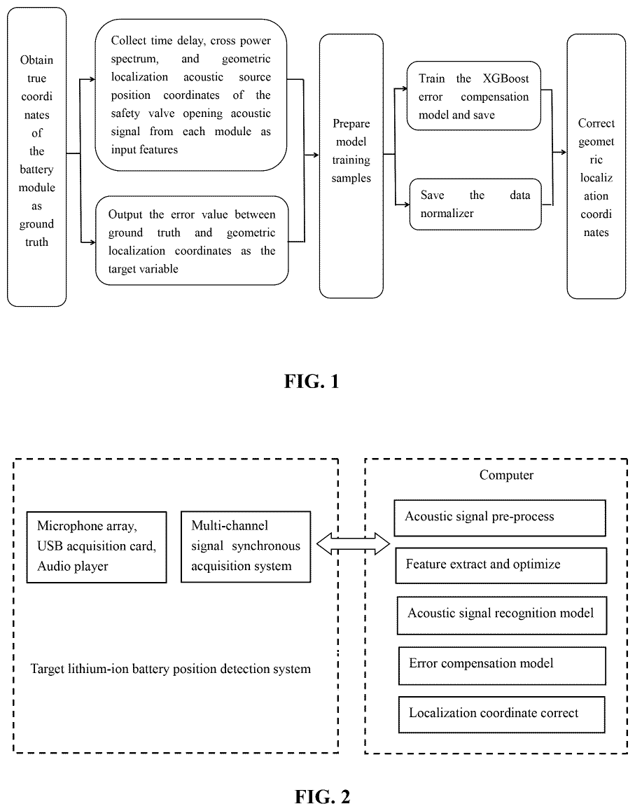

Step S1.1: building a lithium-ion battery thermal runaway acoustic source localization error compensation system, as shown in FIG. 2. The system includes an energy storage cabin for placing a lithium-ion battery, an acoustic acquisition assembly installed in the energy storage cabin, and a controller provided at a remote end, wherein the controller includes an acoustic signal recognition model and an XGBoost model training module.

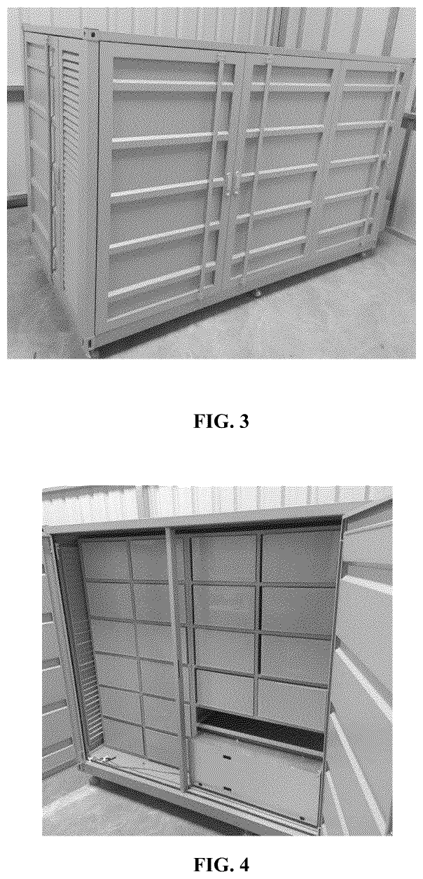

In this embodiment, an equal-scale energy storage cabin equipment model was designed with a length of 2 meters, a width of 1 meter, and a height of 1.2 meters, as shown in FIG. 3.

The acoustic sensor is a microphone.

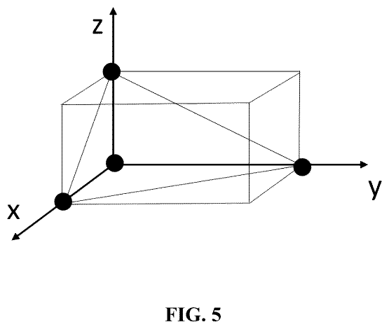

A three-dimensional coordinate system OXYZ is established in the energy storage cabin. The microphone of channel one is located at the coordinate origin, with coordinates (0, 0, 0). The microphone of channel two is located 1 meter from the origin in the x direction, defined as the width direction of the energy storage cabin, with coordinates (100, 0, 0). The channel three microphone is located 2 meters away from the origin in the y-direction, defined as the length direction of the energy storage cabin, with coordinates (0, 200, 0). The channel four microphone is located at a distance of 1.2 m from the origin in the z direction, defined as the height direction of the energy storage cabin, with coordinates (0, 0, 120). See FIG. 4 for the specific layout. A bracket is placed in the energy storage cabin for placing a box to simulate a battery module (see FIG. 4); at the same time, since a coordinate system has been established (see FIG. 5), the three-dimensional coordinates of the safety valve of each box need to be measured as ground truth for subsequent error value calculation; and the error values of the safety valve positions of all modules are collected to train an XGBoost error compensation model. The error is calibrated through multiple experiments and data acquisition, using the known ground-truth coordinates of the box safety valve. The microphone position and array configuration are adjusted to reduce localization errors.

Step S1.2: acquiring training data, specifically including the following steps:
Step S1.2.1: pre-collecting audio of the opening of a real lithium-ion battery safety valve, wherein each audio segment is three seconds in duration and is stored in an audio player;
Step S1.2.2: placing the audio player in the position of the lithium-ion battery in the energy storage cabin in step S1, and playing the audio, simulating a position of the real lithium-ion battery safety valve opening acoustic source, and using an acoustic acquisition assembly to acquire the audio signal for each playback;
Step S1.2.3: performing the operations of step S1.2.2 on each position where the lithium-ion battery is placed in the energy storage cabin, and repeating the operations M times for each position; using an acoustic acquisition assembly to collect four audio signals during each playback, and sending the audio signals to a controller; denoting the four audio signals as a group.

In the present embodiment, audio is played 100 times at each lithium-ion battery position, and the audio signal of each playback is acquired using a microphone array and sent to the controller.

Step S1.3: the controller processing the training data acquired in step S2 and constructing a lithium-ion battery safety valve opening acoustic signal recognition model. Specifically including the following steps:
Step S1.3.1: performing wavelet denoising on the data acquired by each acoustic sensor to remove background noise;
Step S1.3.2: processing an original audio signal by using a pre-emphasis filter to enhance the energy of high-frequency signals;
Step S1.3.3: using Mel-frequency cepstral coefficients MFCC to extract features from the read audio information, and performing normalization on the features extracted for each acoustic sensor;
Step S1.3.4: constructing a feature vector by using a preloaded SVM model, and constructing a dataset based on MFCC parameters to establish a lithium-ion battery safety valve opening acoustic signal recognition model; the lithium-ion battery safety valve opening acoustic signal data identified by the acoustic signal recognition model including the relative time delay, cross power spectrum information, the acoustic source localization coordinates calculated by the geometric method of the sound signals acquired by different sensors, and the error value between the acoustic source actual coordinates and geometric localization coordinates.

The six time delay features include T12, T13, T14, T23, T24, and T34, representing the time delay between each pair of microphones. The 18 cross power spectrum features include the real part of the cross power spectrum R₁₂, R₁₃, R₁₄, R₂₃, R₂₄, R₃₄; the imaginary part is I₁₂, I₁₃, I₁₄, I₂₃, I₂₄, I₃₄; and the magnitude is M₁₂, M₁₃, M₁₄, M₂₃, M₂₄, M₃₄. Geometric localization coordinates (x, y, z) represent the localization coordinates obtained by the spherical interpolation method. The error value (Δx, Δy, Δz) represents the deviation between the geometric localization coordinates and the known ground-truth coordinates.

The results of each experiment form a feature vector and are saved as a .csv file, the name of which includes the feature name. 100 data points are collected for each lithium-ion battery position to form a complete dataset. A total of twenty groups of position data are collected, with 100 data points in each group, resulting in a total of 2,000 data points. Specifically, important features can be added based on the model prediction error at this position to optimize model prediction stability.

Step S1.4: the XGBoost model training module using the lithium-ion battery safety valve opening acoustic signal data identified by the acoustic signal recognition model to train the XGBoost model to predict localization errors.

Before model training, data normalization is performed; the XGBoost regression model xgb.XGBRegressor is initialized, and the objective function is set to mean squared error reg:squarederror. A hyperparameter grid param_grid is defined, which contains multiple hyperparameter options, including the maximum depth of decision trees (max depth, which controls tree depth to prevent overfitting), learning rate (learning rate, which controls the step size of weight updates in each iteration), number of base learners (trees) to train (n estimators), subsampling ratio per tree (subsample), ratio of randomly selected features per tree (colsample bytree; similar to subsample, controlling feature randomization sampling can enhance model robustness), minimum sample weight in subtree and min_child_weight, and regularization weights reg_alpha and reg_lambda. The specific values of the hyperparameters are shown in Table 1.

TABLE 1
Specific values of hyperparameters

| Parameter name | Optimum value |
|---|---|
| colsample_bytree | 0.6 |
| learning_rate | 0.01 |
| max_depth | 5 |
| min_child_weight | 1 |
| n_estimators | 50 |
| subsample | 0.7 |

A grid search was performed using GridSearchCV to find the best combination of hyperparameters, and 5-fold cross-validation (cv=5) was used to evaluate model performance.

Finally, the model is trained and saved using the optimal hyperparameter combination. The trained model was used to predict the test set, and the evaluation metrics were calculated, including mean squared error (mse), root mean squared error (rmse), and R²(r2) score.

Visualize feature importance and display it on the graphical interface to enable targeted addition of important features where subsequent testing is inaccurate. The logging library is used to record important information during the training process, including the best parameters, the best cross-validation score, and evaluation metrics, to facilitate subsequent analysis and debugging. Finally, the data normalizer and the optimal error compensation model are saved for subsequent real-time detection.

Step S2: the acoustic sensor acquiring acoustic information in the energy storage cabin in real time and transmitting to the controller, the controller using the trained battery thermal runaway acoustic source localization error compensation system to achieve real-time accurate localization of the lithium-ion battery thermal runaway acoustic source.

In this embodiment, detection is performed under real-world conditions. The microphone array in the energy storage cabin remains unchanged. The audio player is precisely placed at the position of the simulated battery safety valve to play audio. Signals from multiple microphones are synchronously acquired in real time to obtain complete acoustic field information. The acquired signals are subjected to multi-resolution analysis using the wavelet transform to remove background noise. A clearer signal is extracted through the decomposition, thresholding, and reconstruction steps. A pre-emphasis filter is used to enhance the signal components and improve the performance of subsequent feature extraction. The time delay features and cross power spectrum features are extracted from the denoised and pre-emphasis signals. The generalized cross-correlation phase transform (GCC-PHAT) algorithm was used to estimate the time delay between each pair of microphones, yielding six groups of time delay features. The microphone positions and the corresponding time delays were combined with the spherical interpolation method to calculate the coordinates for geometric localization. Eighteen groups of cross power spectrum features are calculated to describe the frequency-domain characteristics and phase information of the signal.

To eliminate scale differences among different features, the time delay features, cross power spectrum features, and geometric localization coordinates are normalized to ensure consistent input to the error compensation model. The normalized data are input into a pre-trained error compensation model to predict the geometric localization error, expressed in (x, y, z) coordinates. The offset predicted by the error model is applied to the geometric localization coordinates, and the corrected acoustic source position is obtained. This process significantly reduces localization error fluctuations due to environmental instability (e.g., reflections, temperature variations, and device noise).

Through repeated field tests and data collection, the layout of the microphone array and the signal processing algorithms are optimized to adapt to different energy storage cabin designs and environmental conditions, while the error compensation model is continuously updated and trained to improve its adaptability to environmental changes.

Accurately place the audio player at different positions of the simulated battery safety valve for repeated testing. Several groups of experimental data are shown in Table 2, including the ground-truth coordinates of the acoustic source position, the geometric localization coordinates of the acoustic source, and the corrected acoustic source position.

TABLE 2
Simulation experiment data (unit: cm)

| Acoustic source | Acoustic source | |
|---|---|---|
| position | geometric | Corrected acoustic |
| ground-truth | localization | source position |
| coordinates | coordinates | coordinates |
| (63, 118.2, 16.5) | (64, 118, 15) | (64, 118.1, 15.9) |
| (88.2, 94.3, 16.5) | (89, 95, 16) | (88.6, 95, 16.5) |
| (63, 70.5, 87.4) | (52, 73, 80) | (60.1, 72, 80.2) |
| (63, 70.5, 57.4) | (64, 71, 57) | (63.5, 70.7, 57.4) |

As clearly shown in Table 2, the XGboost model is trained using sound feature vectors, and the traditional geometric acoustic source localization coordinates are corrected using the error value obtained by the prediction model; the error between the corrected acoustic source position coordinates and the ground truth is very small, thereby achieving real-time precise localization of the lithium-ion battery thermal runaway acoustic source.

In light of the foregoing description of the preferred embodiments of the present invention, it will be apparent to those skilled in the art that various changes and modifications can be made without departing from the spirit of the present invention. The technical scope of the present invention should not be limited to the description herein but shall be determined according to the scope of the claims.

1. An XGBoost-based lithium-ion battery thermal runaway acoustic source localization error compensation method, characterized by specifically comprising following steps:
step S1: building and training a battery thermal runaway acoustic source localization error compensation system
step S1.1: building a lithium-ion battery thermal runaway acoustic source localization error compensation system; the system comprising an energy storage cabin for placing a lithium-ion battery, an acoustic acquisition assembly installed in the energy storage cabin, and a controller provided at a remote end, wherein the controller comprises an acoustic signal recognition model and an XGBoost model training module;
step S1.2: acquiring training data: specifically comprising following steps:
step S1.2.1: pre-collecting areal lithium-ion battery safety valve opening audio and storing the audio in an audio player;
step S1.2.2: placing an audio player in the position of the lithium-ion battery in the energy storage cabin in step S1, and playing the audio, simulating a position of the real lithium-ion battery safety valve opening acoustic source, and using an acoustic acquisition assembly to acquire the audio signal for each playback;
step S1.2.3: performing the operations of step S1.2.2 on each position where the lithium-ion battery is placed in the energy storage cabin, and repeating the operations M times for each position; using an acoustic acquisition assembly to collect four audio signals during each playback, and sending the audio signals to a controller; denoting the four audio signals as a group;
step S1.3: the controller processing the training data acquired in step S2 and constructing a lithium-ion battery safety valve opening acoustic signal recognition model;
step S1.4: the XGBoost model training module using the lithium-ion battery safety valve opening acoustic signal data identified by the acoustic signal recognition model to train the XGBoost model to predict localization errors;
step S2: the acoustic sensor acquiring acoustic information in the energy storage cabin in real time and transmitting to the controller, the controller using the trained battery thermal runaway acoustic source localization error compensation system to achieve real-time accurate localization of the lithium-ion battery thermal runaway acoustic source.

2. The XGBoost-based lithium-ion battery thermal runaway acoustic source localization error compensation method according to claim 1, characterized in that, in step S1.1, a three-dimensional coordinate system OXYZ is established in the energy storage cabin, and true coordinates of each battery's safety valve are pre-measured;
the acoustic acquisition module comprises four acoustic sensors, respectively denoted as a first acoustic sensor, a second acoustic sensor, a third acoustic sensor, and a fourth acoustic sensor;
wherein the first acoustic sensor is provided at an origin of the three-dimensional coordinate system, the second acoustic sensor is provided on an X-axis of the three-dimensional coordinate system at a distance L1 from the origin; the third acoustic sensor is provided on a Y-axis of the three-dimensional coordinate system at a distance L2 from the origin; the fourth acoustic sensor is provided on a Z-axis of the three-dimensional coordinate system at a distance L3 from the origin.

3. The XGBoost-based lithium-ion battery thermal runaway acoustic source localization error compensation method according to claim 2, characterized in that the acoustic sensor is a microphone.

4. The XGBoost-based lithium-ion battery thermal runaway acoustic source localization error compensation method according to claim 2, characterized in that, in step S1.2.3, the audio player is placed at a safety valve position to play audio; the audio is played 100 times at each battery safety valve position, with an audio duration of 3 seconds.

5. The XGBoost-based lithium-ion battery thermal runaway acoustic source localization error compensation method according to claim 3, characterized in that, in step S1.3, the controller processes the training data acquired in step S2 and constructs a lithium-ion battery safety valve opening acoustic signal recognition model, specifically comprising following steps:
step S1.3.1: performing wavelet denoising on the data acquired by each acoustic sensor to remove background noise;
step S1.3.2: processing an original audio signal by using a pre-emphasis filter to enhance energy of high-frequency signals;
step S1.3.3: using Mel-frequency cepstral coefficients MFCC to extract features from the read audio information, and performing normalization on the features extracted for each acoustic sensor;
step S1.3.4: constructing a feature vector by using a preloaded SVM model, and constructing a dataset based on MFCC parameters to establish a lithium-ion battery safety valve opening acoustic signal recognition model; the lithium-ion battery safety valve opening acoustic signal data identified by the acoustic signal recognition model comprising a relative time delay, cross power spectrum information, acoustic source localization coordinates calculated by the geometric method, of the sound signals acquired by different sensors, and the error value between the acoustic source actual coordinates and geometric localization coordinates.

6. The XGBoost-based lithium-ion battery thermal runaway acoustic source localization error compensation method according to claim 5, characterized in that six time delay differences and eighteen cross power spectra corresponding to each group of audio signals, wherein the time delay differences comprise T₁₂, T₁₃, T₁₄, T₂₃, T₂₄, T₃₄; a real part of the cross power spectra is R₁₂, R₁₃, R₁₄, R₂₃, R₂₄, R₃₄; an imaginary part is I₁₂, I₁₃, I₁₄, I₂₃, I₂₄, I₃₄; and a magnitude is M₁₂, M₁₃, M₁₄, M₂₃, M₂₄, M₃₄; the real part, the imaginary part, the magnitude, and the error value of the time delay cross power spectra are normalized separately, and the normalizers are saved for subsequent real-time detection to normalize new data inputs for comparison.

7. The XGBoost-based lithium-ion battery thermal runaway acoustic source localization error compensation method according to claim 5, characterized in that the relative time delay is obtained by using the generalized cross-correlation algorithm; after windowing each group of four acquired signals, the cross power spectrum is calculated using the Fast Fourier Transform FFT, and phase normalization is applied to minimize the influence of signal strength on time delay estimation; the cross power spectrum is processed by inverse FFT to obtain the cross-correlation result, and the time delay estimation value is calculated, which provides accurate time difference data for subsequent localization;
wherein the signal is windowed to reduce spectral leakage, and the specific calculation formula is as follows:
$$w [ k ] = 0.5 ( 1 - cos ( \frac{2 π k}{K - 1} )$$
wherein w[k] is the Hanning Window function, and K is the length of the signal, namely, the total number of signal sampling points; k represents the position index of the current window function, where k=0, 1, . . . , K−1;
windowed signal: sig_{w}=sig·w; refsig_{w}=refsig·w;
w is the weight array of the window function, with a length equal to that of sig and refsig, enabling the signal edges to transition smoothly to zero and thereby reducing spectral leakage and improving the frequency-domain energy distribution;
performing the Fast Fourier Transform FFT calculation on the sound signal:
SIG(f)=F(sig_{w}), REFSIG(f)=F(refsig_{w})
wherein F represents the Fast Fourier Transform, and SIG(f) and REFSIG(f) are the frequency-domain representations of sig_{w} and refsig_{w}, respectively;
$$R ( f ) = SIG ( f ) \cdot REFSIG * ( f )$$
where REFSIG*(f) is the complex conjugate of REFSIG(f);
normalizing cross power spectrum:
$$\hat{R} ( f ) = \frac{R ( f )}{\vert R ( f ) \vert + ε}$$
where |R(f)| is the amplitude of the cross power spectrum and ∈ is a constant;
$$r ( τ ) = {F}^{- 1} ( \hat{R} ( f )$$
where F⁻¹ represents the inverse Fourier transform and r(τ) is the cross-correlation function
$$cc = [ r ( - {τ}_{max} ) , ⋯ ⋯ , r ( {τ}_{max} ]$$
$$τ = \frac{arg max ( \vert cc \vert ) - {τ}_{max}}{interp \cdot fs}$$
wherein τₘₐₓ is the maximum time delay, argmax(|cc|) is the position of the maximum cross-correlation value, interp is the interpolation factor, and fs is the sampling rate;
the real part, the imaginary part, and the magnitude of the cross-power spectrum are extracted as features:
$$Re ( R ( f ) ) = real ( R ( f ) )$$
$$Im ( R ( f ) ) = imag ( R ( f ) )$$
$$\vert R ( f ) \vert = \sqrt{{Re ( R ( f ) )}^{2} + {Im ( R ( f ) )}^{2}}$$
wherein R(f) is the cross power spectrum of the signal sig and the reference signal refsig, Re(R(f)) is the real part of the cross power spectrum, Im(R(f)) is the imaginary part of the cross power spectrum, and |R(f)| is the magnitude of the cross power spectrum.

8. The XGBoost-based lithium-ion battery thermal runaway acoustic source localization error compensation method according to claim 7, characterized in that a nonlinear equation is constructed for each acoustic sensor to represent a relationship between a distance difference from the acoustic source to the acoustic sensor and a distance difference corresponding to the time delay difference; first, the acoustic sensor located at the coordinate origin is set as the reference acoustic sensor, and the distance R₀ from the reference acoustic sensor to the acoustic source is calculated:
$${R}_{0} = \sqrt{{x}^{2} + {y}^{2} + {z}^{2}}$$
then, the distance Rᵢ from each i^{th} acoustic sensor to the acoustic source is calculated:
$${R}_{i} = \sqrt{{( x - {x}_{i} )}^{2} + {( y - {y}_{i} )}^{2} + {( z - {z}_{i} )}^{2}}$$
then, the distance difference corresponding to the time delay difference is calculated:
$${d}_{i} = {τ}_{i} \cdot c$$
then, a nonlinear equation is constructed:
$${R}_{i} - {R}_{0} - {d}_{i} = 0$$
the nonlinear least squares method is used for optimization, the objective is to minimize the residuals of the above set of equations:
$${min}_{( x , y , z )} {\sum }_{i = 1}^{N - 1} {( \sqrt{{( x - {x}_{i} )}^{2} + {( y - {y}_{i )} )}^{2} + {( z - {z}_{i} )}^{2}} - \sqrt{{x}^{2} + {y}^{2} + {z}^{2}} - {τ}_{i} \cdot c )}^{2}$$
wherein the acoustic source position coordinates are (x, y, z); (xᵢ, yᵢ, zᵢ) are the position coordinate of the i^{th} acoustic sensor; Ti is the time delay difference of the i^{th} acoustic sensor; c is the speed of sound; R₀ is the distance from the acoustic source to the reference acoustic sensor; Rᵢ is the distance from the acoustic source to the i^{th} acoustic sensor; dᵢ is the distance difference corresponding to the time delay difference of the i^{th} acoustic sensor; N is the number of acoustic sensors; min_{(x, y, z)} is the minimized the objective function.

9. The XGBoost-based lithium-ion battery thermal runaway acoustic source localization error compensation method according to claim 8, characterized in that, in step S1.4, acoustic source position coordinates obtained by geometric localization calculation are set as (x, y, z), and an error predicted by the XGBoost is (Δx, Δy, Δz); thus, corrected precise acoustic source position coordinates are (x+Δx, y+Δy, z+Δz).

10. The XGBoost-based lithium-ion battery thermal runaway acoustic source localization error compensation method according to claim 9, characterized in that, in step S2, the controller processes the received sound signal using the trained battery thermal runaway acoustic source localization error compensation system, specifically comprising:
step S2.1: performing normalization processing on the extracted features using the method described in step S1.3, and using a pre-trained SVM model and normalizer to predict whether the sound signal is the sound of a lithium-ion battery safety valve opening, if so, setting the lithium-ion battery as the target lithium-ion battery;
step S2.2: acquiring acoustic signals of the target lithium-ion battery identified in the energy storage cabin in real time; calculating time delays, cross power spectrum data, and acoustic source localization coordinates calculated by a traditional geometric method; and inputting into the normalizer according to claim 6, using the pre-trained normalizer to normalize each feature data frame to ensure that different features are on a same scale; the normalized feature arrays being stacked horizontally to form a comprehensive feature matrix containing all features used for model prediction; using a loaded model to predict the combined features, and outputting an error value;
step S2.3: using the error value predicted by the model to correct the acoustic source position coordinates output by the geometric localization method, and finally determining an accurate position of the target lithium-ion battery.
